(19) United States
(12) Patent Application Publication
(10) Pub. No.: US 2008/0011237 A1
(43) Pub. Date: Jan. 17, 2008

(54) AQUARIUM

(76) Inventor: Pang-Ting TIEN, Kaosiung Hsien (TW)

Correspondence Address: OSTROLENK FABER GERB & SOFFEN, 1180 AVENUE OF THE AMERICAS, NEW YORK, NY, 100368403, US

(21) Appl. No.: 11/457,910

(22) Filed: Jul. 17, 2006

(51) Int. Cl. A01K 63/00

(52) U.S. Cl. 119/248

(57) ABSTRACT

An aquarium includes a base tank, and a container having a lower open end portion disposed in a first accommodating space in the base tank and mounted on a container-mounting seat mounted fixedly on a bottom wall of the base tank. A second accommodating space in the container is in fluid communication with the first accommodating space in the base tank. The container has a top end higher than that of a surrounding wall of the base tank. When the first accommodating space in the base tank is filled with water, a part of water contained in the base tank flows into the second accommodating space in the container via the lower open end portion by extracting air outwardly of the second accommodating space in the container such that a level of the water contained in the base tank is lower than that of water contained in the container.

### BACKGROUND OF THE INVENTION

1. Field of the Invention

The invention relates to an aquarium, more particularly to an aquarium that can result in two different water levels.

2. Description of the Related Art

Referring to FIG. 1, a conventional aquarium 1 is shown to include a tank body 11 that has a bottom wall 111, and a transparent surrounding wall 112 extending upwardly from a periphery of the bottom wall 111 and cooperating with the bottom wall 111 to define an accommodating space 10. A filter 12 is mounted on the surrounding wall 112 of the tank body 11. It is noted that the conventional aquarium 1 has a monotonous and unattractive appearance.

### SUMMARY OF THE INVENTION

Therefore, the object of the present invention is to provide an aquarium that can result in two different water levels.

According to the present invention, an aquarium comprises:

a base tank having a bottom wall, a surrounding wall extending upwardly from a periphery of the bottom wall and cooperating with the bottom wall to define a first accommodating space, and a container-mounting seat disposed in the first accommodating space and mounted fixedly on the bottom wall; and

a container configured with a second accommodating space and having a lower open end portion disposed in the first accommodating space in the base tank and mounted on the container-mounting seat of the base tank, the second accommodating space in the container being in fluid communication with the first accommodating space in the base tank, the container having a top end higher than that of the surrounding wall of the base tank.

When the first accommodating space in the base tank is filled with water, a part of water contained in the base tank flows into the second accommodating space in the container via the lower open end portion by extracting air outwardly of the second accommodating space in the container such that a level of the water contained in the base tank is lower than that of water contained in the container.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic sectional view of a conventional aquarium;

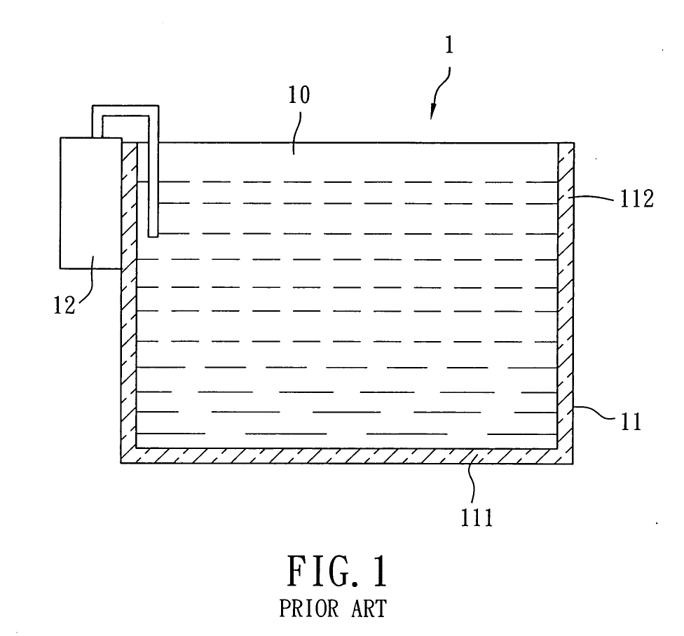

FIG. 2 is an exploded schematic sectional view showing the first preferred embodiment of an aquarium according to the present invention;

FIG. 3 is an assembled schematic sectional view showing the first preferred embodiment;

FIG. 4 is an assembled schematic sectional view showing the first preferred embodiment when in a water-exchanging state;

FIG. 5 is a perspective view showing the second preferred embodiment of an aquarium according to the present invention;

FIG. 6 is a schematic sectional view showing the second preferred embodiment;

FIG. 7 is a perspective view showing the third preferred embodiment of an aquarium according to the present invention; and

FIG. 8 is an assembled schematic sectional view showing the third preferred embodiment.

### DETAILED DESCRIPTION OF THE PREFERRED EMBODIMENTS

Before the present invention is described in greater detail, it should be noted that like elements are denoted by the same reference numerals throughout the disclosure.

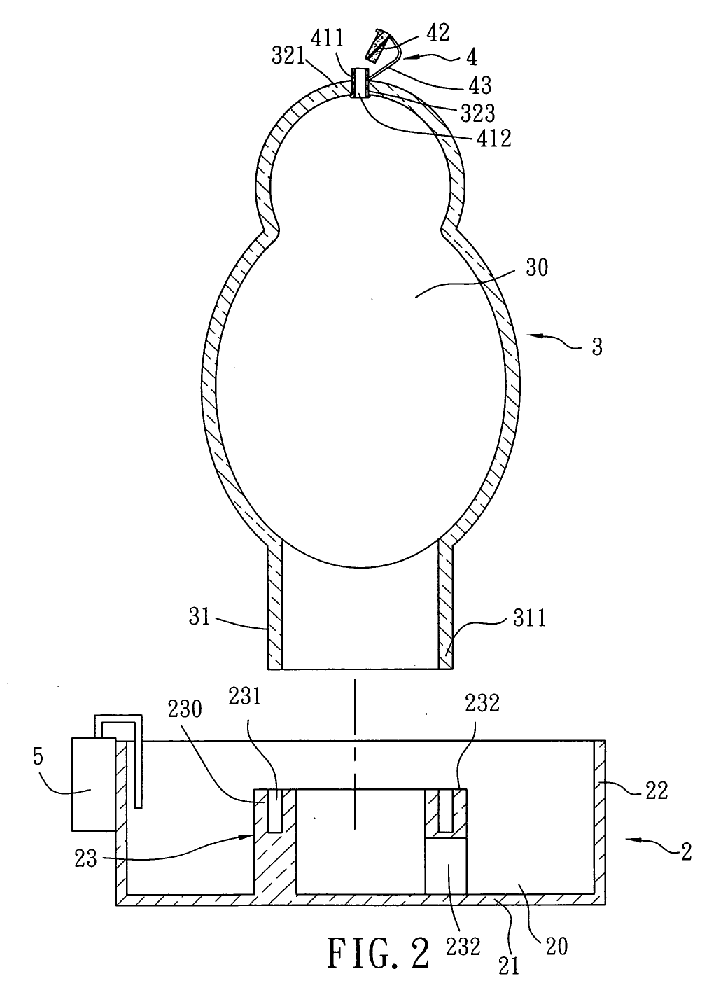

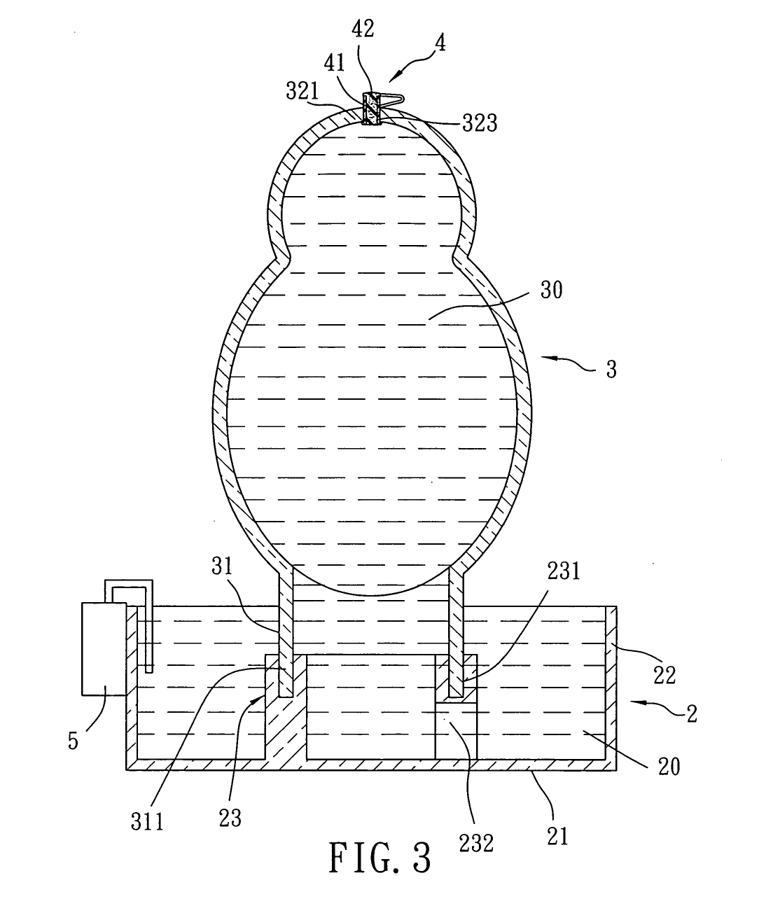

Referring to FIGS. 2 and 3, the first preferred embodiment of an aquarium according to the present invention is shown to include a base tank 2 and a container 3.

The base tank 2 has a bottom wall 21, an annular surrounding wall 22 extending upwardly from a periphery of the bottom wall 21 and cooperating with the bottom wall 21 to define a first accommodating space 20, and a container-mounting seat 23 disposed in the first accommodating space 20 and mounted fixedly on the bottom wall 21. In this embodiment, the container-mounting seat 23 has an annular seat wall 230 that extends integrally and upwardly from the bottom wall 21 of the base tank 2, that is formed with a passage 232, and that has an annular top surface 232, which is formed with an annular groove 231.

The container 3 is made of a transparent material, is configured with a second accommodating space 30 that is in fluid communication with the first accommodating in the base tank 2 via the passage 232, and has a lower open end portion 31 disposed in the first accommodating space 20 in the base tank 2 and mounted on the container-mounting seat 23. In this embodiment, the lower open end portion 31 of the container 3 has an annular wall 311 that engages the annular groove 231 in the annular top surface 232 of the annular seat wall 230 of the container-mounting seat 23, as shown in FIG. 3. The container 3 has a top end 32 higher than that of the annular surrounding wall 22 of the base tank 2. In this embodiment, the top end 32 of the container 3 is provided with an air valve 4 that is made of rubber or silicone and that includes a valve seat 41 mounted sealingly in a valve-mounting hole 323 in the top end 32 of the container 3 and having a valve hole 412 for access into the second accommodating space 30 in the container 3, and a valve plug 42 plugged sealingly and detachably into the valve hole 412 in the valve seat 41. A filter 5 is mounted on the annular surrounding wall 22 of the base tank 2.

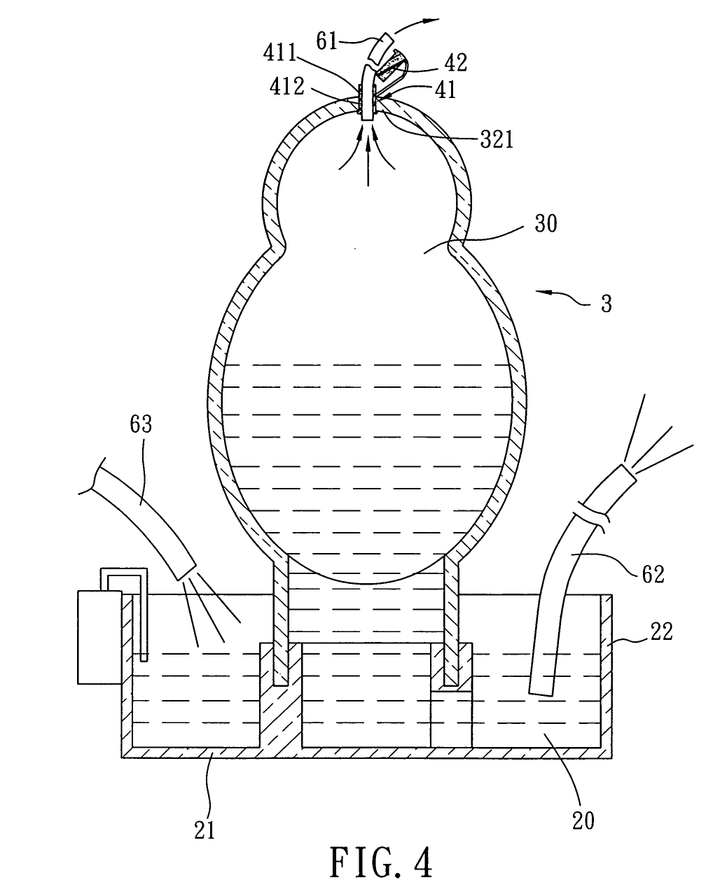

In actual use, before filling with water, sand and various decorative articles can be selectively arranged in the base tank 2. Then, when the first accommodating space 20 in the base tank 2 is filled with water, a part of water contained in the base tank 2 flows into the second accommodating space 30 in the container 3 via the lower open end portion 31 by extracting air outwardly of the second accommodating space 30 in the container 3 such that a level of the water contained in the base tank 2 is lower than that of water contained in the container 3. Referring further to FIG. 4, in this embodiment, air is extracted outwardly of the second accommodating space 30 in the container 3 via the valve hole 412 in the valve seat 41 of the air valve 4 by means of an air tube 61 inserted sealingly into the valve hole 412 in the valve seat 41 of the air valve 4 and connected to an air pump (not shown). When water fills up the entire second accommodating space 30 in the container 3, the air tube 61 is removed from the valve seat 41, and the air plug 42 is plugged sealingly into the valve hole 412 in the valve seat 41. In other embodiments, the air valve 4 can be replaced by an air pump. When exchanging water, a water pipe 63 for filling water into the first accommodating space 20 in the base tank 2, and another water pipe 62 for drawing the water outwardly of the first accommodating space 20 in the base tank 2 can be used.

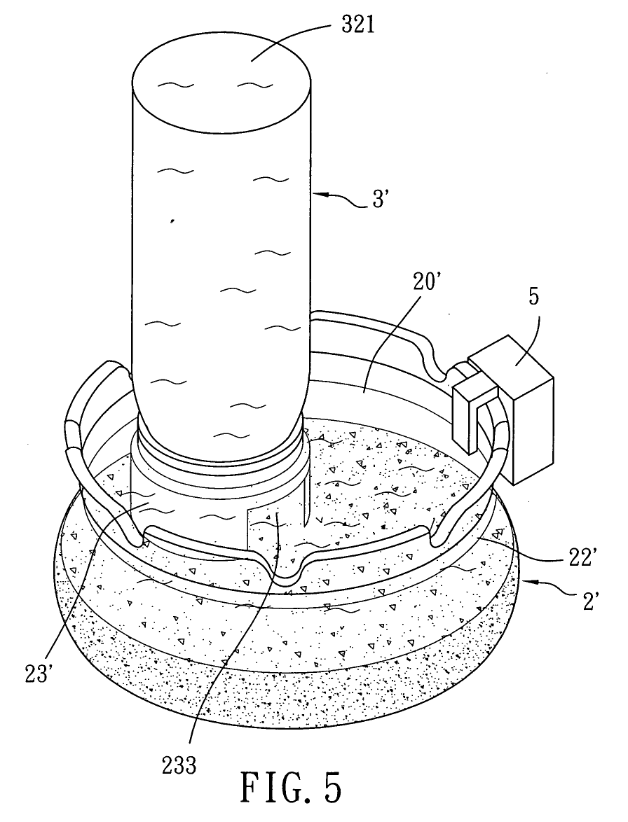

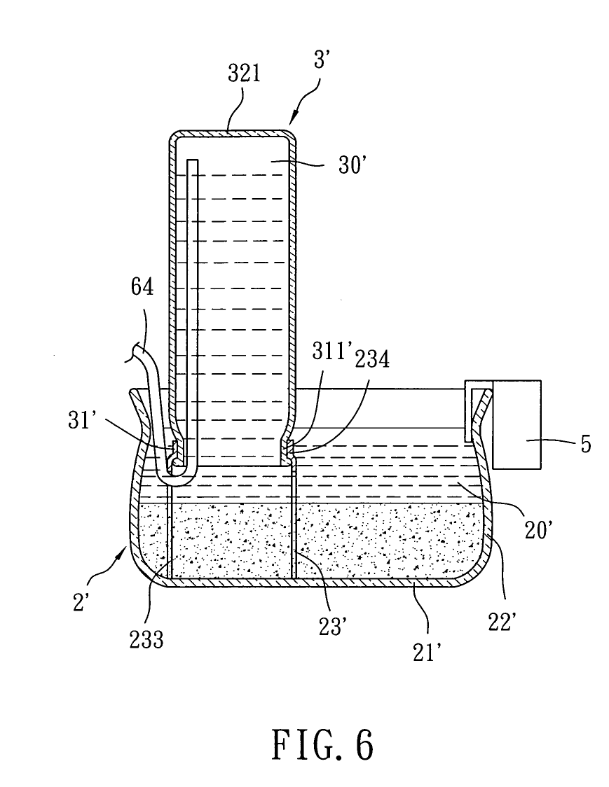

FIGS. 5 and 6 illustrate the second preferred embodiment of an aquarium according to this invention, which is a modification of the first preferred embodiment. In this embodiment, the container-mounting seat 23′ of the first base tank 2′ is in the form of a sleeve, and has a lower end connected integrally to the bottom wall 21′, and an upper end 234 sleeved sealingly on the annular wall 311′ of the lower open end portion 31′ of the container 3′. In this embodiment, when filling with water, an air pipe 64 is inserted into the first accommodating space 20′ in the base tank 2′, and is then extended into the second accommodating space 30′ in the container 3′ via an opening 233 in the container-mounting seat 23′, and the lower open end portion 311′ of the container 3' so as to extract air outwardly of the second accommodating space 30′ in the container 3′, as shown in FIG. 6.

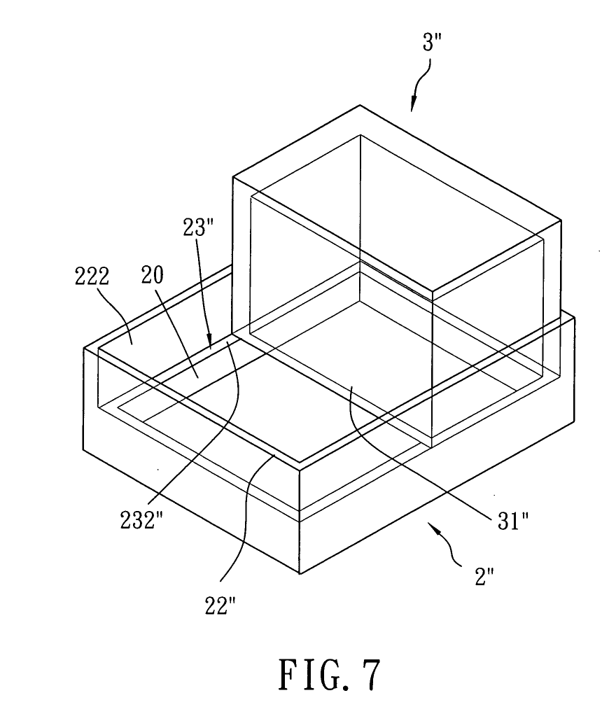

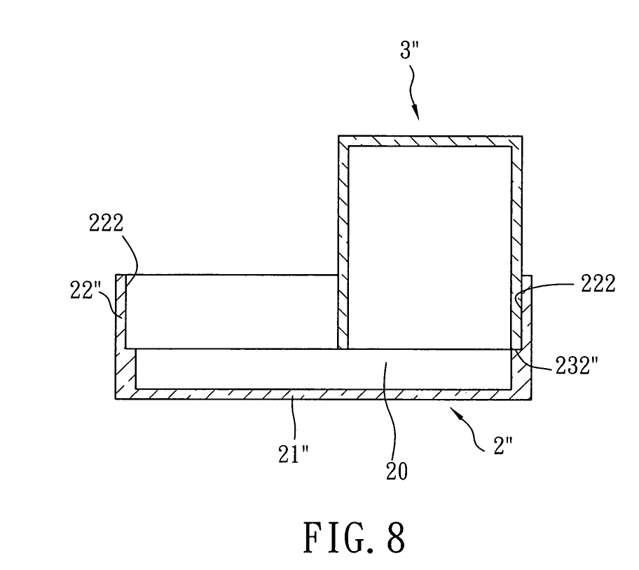

FIGS. 7 and 8 illustrate the third preferred embodiment of an aquarium according to the present invention, which is a modification of the first preferred embodiment. In this embodiment, the container-mounting seat 23″ of the base tank 2″ is configured as a rectangular seat wall that extends upwardly from the bottom wall 21″ of the base tank 2″ and that is formed integrally with an inner surface 222 of the surrounding wall 22″ of the base tank 2″. The container-mounting seat 23″ has a height smaller that that of the annular surrounding wall 22″ of the base tank 2″. The base tank 2″ is rectangular. The lower open end portion 31″ of the container 3″ is rectangular, has an area smaller than that of the base tank 2″, and abuts against a top surface 232″ of the container-mounting seat 23″.

In sum, due to the presence of the container 3, 3′ 3″ whose shape is not limited, the aquarium of this invention can result in two different water levels and, thus, an attractive appearance.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An aquarium comprising:
a base tank having a bottom wall, a surrounding wall extending upwardly from a periphery of said bottom wall and cooperating with said bottom wall to define a first accommodating space, and a container-mounting seat disposed in said first accommodating space and mounted fixedly on said bottom wall; and
a container configured with a second accommodating space and having a lower open end portion disposed in said first accommodating space in said base tank and mounted on said container-mounting seat of said base tank, said second accommodating space in said container being in fluid communication with said first accommodating space in said base tank, said container having a top end higher than that of said surrounding wall of said base tank;
whereby, when said first accommodating space in said base tank is filled with water, a part of water contained in said base tank flows into said second accommodating space in said container via said lower open end portion by extracting air outwardly of said second accommodating space in said container such that a level of the water contained in said base tank is lower than that of water contained in said container.

2. The aquarium as claimed in claim 1, wherein said top end of said container is provided with an air valve.

3. The aquarium as claimed in claim 1, wherein said container-mounting seat of said container has a seat wall extending upwardly from said bottom wall of said base tank and formed with a passage for intercommunicating said first and second accommodating spaces.

4. The aquarium as claimed in claim 3, wherein:
said lower open end portion is configured as an annular wall; and
said seat wall of said container-mounting seat has an annular top surface that is formed with an annular groove engaging said annular wall of said lower open end portion of said container.

5. The aquarium as claimed in claim 1, wherein said container-mounting seat is configured as a seat wall that extends integrally and upwardly from said bottom wall of said base tank and that is formed integrally with an inner surface of said surrounding wall of said base tank, said seat wall of said container-mounting seat having a height smaller than that of said surrounding wall of said base tank, said lower open end portion of said container abutting against a top surface of said seat wall of said container-mounting seat.

6. The aquarium as claimed in claim 1, further comprising a filter mounted on said surrounding wall of said base tank.
